(19) United States
(12) Patent Application Publication
(10) Pub. No.: US 2016/0260128 A1
(43) Pub. Date: Sep. 8, 2016

(54) SYSTEM AND METHOD FOR TRACKING PROPERTY TRANSACTIONS AND LINKING TO BUYERS

(71) Applicant: VENDIGI, INC., San Diego, CA (US)

(72) Inventors: Gary Trent Gardner, San Marcos, CA (US); Ata Hassan, San Diego, CA (US); Ram Babu Chintala, San Diego, CA (US); Anil Srinivas Guntur, San Diego, CA (US)

(73) Assignee: VENDIGI, INC.

(21) Appl. No.: 14/637,321

(22) Filed: Mar. 3, 2015

(51) Int. Cl. G06Q 30/02; G06Q 50/16

(52) U.S. Cl. CPC G06Q 30/0255; G06Q 50/167

(57) ABSTRACT

Systems and methods to provide targeted advertising use tracking of stages of prospective real estate purchases. Demand-side platforms may request information, e.g. one or more characteristics of a particular prospective real estate purchase, the information being related to either one or more particular device identifiers, or being related to one or more specified criteria for characteristics of prospective real estate purchases. In response to the request, a response is initiated. Content providers that provided content relevant to the response are compensated based on revenue received from the demand-side platforms.

### FIELD

The disclosure relates to systems and methods for providing and/or enabling targeted advertising and, in particular, advertising based on information gathered through the activity on client computing platforms of users/buyers in the process of purchasing real estate.

### BACKGROUND

Users can access online services, applications, and web pages via the internet, for example through client computing platforms. Presenting information depicted as images is known. Online services, web pages, and/or applications may include content presented by real estate search servers and other servers. Presenting information to client computing platforms that are connected to the internet is known. Organizing such information in digital media files, such as web pages, is known. Using a browser software application to present a web page and/or other information on a client computing platform is known. Hosting sets of digital media files, for example organized in a database, through a media host server is known. A server accessing a media host server to present a digital media file to a client computing platform is known.

### SUMMARY

One aspect of the disclosure relates to systems configured to provide targeted advertising. The system may facilitate communication between users and providers of real estate-related content, service providers, online services, media host servers, search servers, ad servers, demand-side platforms, web-based (property) transaction-support systems, companies involved in real estate transactions, providers of systems that may be engaged during the life cycle of a real estate transaction, and/or other entities, which may collectively be referred to as content providers. The system may facilitate communication between different content providers. The system and/or components related to the system may pertain to real estate and/or real estate transactions. As used herein, the term “transaction” includes activities in any stage of a prospective real estate purchase. The system and/or any entities that communicate with the system may be deployed using a (public) network and/or using commercial web services. The system may facilitate communication between content providers and users (e.g. prospective buyers and sellers of real estate), for example through client computing platforms.

Client computing platforms may include one or more processors configured to execute computer program components. The computer program components may be configured to enable a user associated with a client computing platform to interact with the system, any component thereof, other client computing platforms, and/or provide other functionality attributed herein to client computing platforms. By way of non-limiting example, client computing platforms may include one or more of a desktop computer, a laptop computer, a handheld computer, a NetBook, a Smartphone, a tablet, a mobile computing platform, a gaming console, a television, a device for streaming internet media, and/or other computing platforms.

Transactions may be (activities that are) related to one or more stages of a (prospective) real estate purchase. The stages of real estate purchases may include, by way of non-limiting example, a property searching stage, a mortgage searching stage, an agent searching stage (buyer and/or seller), a loan application stage, a loan approval stage, an agent contracted stage, an offer submission stage, an offer acceptance stage, a contingency stage, an escrow stage, a purchase completion stage, and a post-purchase stage. Different professionals, services, and/or companies may be involved in one or more stages. The order of these stages is not intended to be limited in any way. At least some of these stages (or parts thereof) can be worked on and/or completed using web-based tools and/or web-based services. Web-based systems that support any part and/or stage of real estate transactions may be referred to as web-based transaction-support systems or web-based property-transaction support systems.

Support through a web-based transaction-support system may include the provision of web pages, (mobile) applications, apps, stand-alone applications, desktop applications, and/or other types of software applications capable of interacting with a network, for example the internet. As used herein, content provided through any type of software application capable of interacting with a network may be referred to as web pages (including, but not limited to, mobile applications or “apps”).

Web pages may be rendered, interpreted, and/or displayed for presentation using a computing platform, such as a client computing platform. As used herein, displaying information through a mobile application—or app—is included in the term presentation. Presentation of web pages may be supported through a display, screen, monitor of the computing platform, and/or projection by the computing platform. Web pages may be accessible from a local computing platform (e.g. not currently connected to the internet) and/or hosted by a remote web server (e.g. connected to the internet and/or one or more other networks). Web pages may be accessed through a browser software application being executed on a computing platform. As used herein, mobile applications may be included in the term browser software application. Web pages may be static (e.g. stored using electronic storage that is accessible by a web server), dynamic (e.g. constructed when requested), and/or a combination of both. The browser software application may be configured to render, interpret, and/or display one or more web pages for presentation using a computing platform. The digital content included in a web page may have been provided by one or more content providers. A set of linked and/or organized web pages may form a website. A website may include a set of related and/or linked web pages hosted on one or more web servers and accessible via a network, e.g. the internet. Websites and/or web pages may be accessible through an address called a uniform resource locator (URL). Servers may include search servers, media host servers, ad servers, demand-side platforms, and/or other servers.

By way of non-limiting example, web-based transaction-support systems may include web-based public records, real estate search sites, multiple listing service (MLS) sites, real estate agents sites, real estate brokers sites, agent-buyer collaboration sites, web-based loan approval systems, web-based real estate transaction management systems, web-based point-of-sale systems, web-based customer relationship management (CRM) systems, comparative market analysis (CMA) systems, web-based document management systems, web-based form management systems, web-based escrow systems, and/or other systems.

By virtue of the systems and methods described in this disclosure, information related to one or more stages of (prospective) real estate transactions may be correlated, linked, associated, and/or otherwise combined with information that identifies users and/or devices, such as client computing platforms, used by users. The latter information may in turn be used, e.g. after being sold to a demand-side platform, to provide targeted advertising. Targeted advertising may be targeted, e.g., to users and/or devices. Targeted advertising may be of interest to commercial entities, including but not limited to ad servers, search servers, third-party ad brokers, demand-side platforms, and/or other commercial entities involved in buying or selling advertisements on the internet.

A demand-side platform may be configured to provide a market, auction-house, and/or exchange pertaining to advertising, e.g. online advertising. In some embodiments, a demand-side platform provides ad exchange accounts and/or data exchange accounts for advertisers. In some embodiments, a demand-side platform enables (real-time) bidding for displaying online ads. In some embodiments, a demand-side platform may issue and/or transmit a request for and/or invitation to acquire information. The information may pertain to particular users, particular user identifiers that identify particular users, particular devices, and/or particular device identifiers. In some embodiments, the request may be for a set of (user and/or device) identifiers that correspond to users and/or devices that satisfy one or more criteria.

The criteria may include one or more of demographic criteria, characteristics of (prospective) real estate transactions, usage criteria, device criteria, and/or other criteria. Demographic criteria may include statistical characteristics of the users themselves. Characteristics of (prospective) real estate transactions may include characteristics of real estate properties. Characteristics of (prospective) real estate transactions may include characteristics of real estate properties and/or information specific to any stage of (prospective) real estate transactions. For example, a non-limiting example of such a characteristic may be a range or limit of the amount for which a prospective buyer has been pre-approved for a mortgage. Usage criteria may include information about usage by the users of one or more websites, applications, platforms, and/or other systems. For example, a non-limiting example of usage criteria may correspond to users that have been presented with digital content pertaining to specified criteria. In some embodiments, the presented digital content pertains to real estate transactions, for example real estate transactions that meet one or more specified criteria. By way of non-limiting example, the specified criteria for real estate transactions may be based on attributes of the real estate and/or a real estate listing including one or more of geographic area, property value, property age, zoning type of the property, and/or other attributes or characteristics.

A search server may host a website that that allows users to interact and/or engage with (searchable) information, including but not limited to information related to one or more stages of (prospective) real estate transactions. User may interact through user interfaces that are displayed and/or presented on client computing platforms. For example (as may be related to a property searching stage), a real estate search server may allow a user to interact and/or engage with a set or database of real estate content (for example, real estate listings). Users may use a real estate search server to search, e.g. by entering a web search query, for real estate listings that match certain criteria. For example, criteria may pertain, by way of non-limiting example, to location, zip code, school district, property style, average household income in the neighborhood, available views from the property, size, price, price range, a particular listing agent, views associated with the property, and/or other listing information, property information, and/or area-specific (demographic) information. Information related to entered queries may be processed, analyzed, recorded, packaged, offered for sale, exchanged, combined with other information, and/or sold. In response to a web search query from a particular user through a particular client computing platform, a search server may provide access to and/or present one or more digital media files, e.g. through one or more web pages. The one or more web pages may be presented (or displayed for presentation) to the particular user by a browser software application that is being run or executed on the particular client computing platform.

A media host server may host a website that provides storage for, management of, organization of, and/or access to electronic files, e.g. digital media files such as web pages, and/or content particles of such digital media files. Content particles of digital content may include any portion and/or section of such content. In some embodiments, a content particle may be a single pixel. In some embodiments, content particles may be used as part of a tracking mechanism that tracks which digital content is provided to which users and/or devices. Tracking mechanisms are not intended to be limited to mechanisms using content particles.

The media host server may include an online real estate listing service (and/or any web-based transaction-support system) that provides access to digital media files pertaining to real estate transactions. Alternatively, and/or simultaneously, the media host server may be associated with content providers that provide access to digital media files. For example, the content providers may include brokerage firms and/or other people and entities that may be related to or interested in real estate and/or real estate transactions, as well as intermediaries and/or associates of such people and entities that provide access to digital media files pertaining to real estate transactions.

Online entities may be able to provide electronic files to a media host server such that the media host server may provide access to those electronic files at a future time. For example, one or more listing agents may provide digital media files pertaining to real estate listings to a media host server, which in turn may be accessed by one or more real estate search servers, e.g. in response to searches and/or queries from users as described above in relation to real estate search servers. Real estate search servers may locally store copies of the digital media files that are managed and/or organized by a media host server, and/or locally store links, such as URLs, to digital media files that are managed and/or organized by a media host server. In some embodiments, content particles of digital media files are hosted by the media host server and not hosted by other servers such as real estate search servers, such that access to these content particles may be tracked regardless of which server hosts the related digital media files.

An ad server may host and/or provide digital content, usually of a commercial nature and usually to other servers, to be presented for display on client computing platforms. The presentation of digital content may occur in conjunction with the presentation of one or more digital media files, web pages, and/or other digital content used by web-based transaction-support systems. The digital content may include one or more of advertisements, coupons, offers, sales information, branding information, and/or other information of a commercial nature. These types of information of a commercial nature may jointly be referred to as “ads” or “advertisements” throughout this disclosure.

For example, a particular server may be provided with digital content that includes advertisements. The particular server may host a website. A website may include a plurality of web pages. Hosting the website may include transmitting copies of files (e.g., HTML files, XML files, and/or other files) that facilitate assembly and presentation of the web pages on devices remote from the server (e.g., a client computing platform associated with a user). By way of non-limiting example, the hosted website may include one or more of a real estate website, a news portal, a social media website, and/or any other website. The hosted website may present digital content that includes advertisements targeted at different groups of users. In other words, different users may be presented with different digital content and/or different advertisements. The groups of users may be differentiated by one or more of demographic characteristics, geographic characteristics, stated interests, determined and/or expected interests, prior browsing activity, search history, and/or other ways to differentiate users. This list is exemplary and not intended to be limiting in any way. For example, the groups of users may be differentiated based on a particular geographic area that the users are based in, interested in, and/or have a relation with in any other manner. The advertisements provided to such a group of users may be targeted to the particular geographic area.

It is noted that even though groups of users may be differentiated based on information from a particular type, category, and/or industry, e.g. based on information gathered from online activity, the advertisements provided to such a group need not be limited to real estate-related advertisements. Note that the website hosted by the particular server that serves such advertisements may be unrelated to real estate. The providers of digital content, e.g. pertaining to real estate transactions, may share revenue from ads targeted by virtue of the gathered information about users. The information may be gathered by virtue of the users viewing the digital content from the content providers, or having been presented with the digital content.

The system may include a server that communicates with, by way of non-limiting example, one or more of a media host server, one or more (real estate) search servers, one or more web-based transaction-support systems, one or more client computing platforms that are associated with one or more users, and/or other systems and/or entities described herein. Individual users may interact, e.g. through browser software applications being executed on client computing platforms, with one or more servers. For example, users may interact with real estate search servers to search for information pertaining to real estate listings. A search server may access the media host server to access and/or retrieve one or more pertinent digital media files that are relevant to one or more particular web search queries. The one or more pertinent digital media files may then be presented for display to the one or more users in responsive to entered web search queries. When a digital media file is presented for display, the browser software application may engage a marker that is embedded within the digital media file. Alternatively, and/or simultaneously, when a digital media file is presented for display, the browser software application may engage a content particle identifier that identifies a content particle of a digital media file. Responsive to such an engagement, the server may receive one or more transmissions that indicate occurrences of specific digital media files being presented for display. The server may thus track the use and/or presentation of digital media files, e.g. digital media files pertaining to real estate transactions. A similar tracking mechanism may be used for other web-based transaction-support systems.

The server may include one or more processors configured to execute computer program components. The computer program components configured to track digital content and/or real estate transactions on the internet, particularly digital media files pertaining to real estate transactions, may include a transaction correlation component, a request component, a characteristics component, a transmission component, a report component, a property correlation component, a personal correlation component, a connection component, a criteria component, and/or other components.

The transaction correlation component may be configured to determine correlations between transactions and identifiers. Transactions may be related to one or more stages of (prospective) real estate transactions, such as a real estate purchase. The identifiers may include one or more of a user identifier, a device identifier, and/or other identifiers. User identifiers may identify users. Examples of user identifiers may include names, user names, social security numbers, tax payer identification numbers, and/or other types of user identifiers. Device identifiers may identify machines, including but not limited to client computing platforms. Device identifiers may include one or more of an internet protocol (IP) address, a media access control (MAC) address, a browser cookie, information about hardware and/or software configuration of a client computing platform, and/or other information that may be used to identify and/or track a client computing platform as it interacts on the internet. For example, Flash™ and Java© technologies may enable device tracking without using browser cookies or relying on IP addresses. Device identifiers may be related to one or more stages of (prospective) real estate transactions, in particular (prospective) real estate transactions that are correlated to (user and/or device) identifiers.

The request component may be configured to obtain requests for information. In some embodiments, a request may be obtained from a demand-side platform. The requested information may include one or more characteristics of (prospective) real estate transactions. For example, the requested information may include one or more characteristics of a (prospective) real estate transaction that is correlated to a particular (user and/or device) identifier that is included in the request. Alternatively, and/or simultaneously, the requested information may include a request for a set of user identifiers that correspond to particular users. The particular users may be selected to meet one or more requested criteria. In some embodiments, the requested user identifiers may correspond to users that have been presented with particular digital content. The particular digital content may include and/or be related to a real estate transaction (or a real estate listing). The requested criteria may pertain to a real estate transaction. For example, the requested criteria may include a threshold or range for the property value of the real estate property that is the subject of a real estate transaction. For example, the request criteria may include a geographic area for real estate transactions. Multiple criteria may be logically combined for a request.

The characteristics component may be configured to determine characteristics of (prospective) real estate transactions. Determinations by the characteristics component may be based on information relevant to one or more stages of (prospective) real estate purchases. Relevant information may be provided by content provider, web-based transaction-support systems, real estate agents, and/or other sources of information.

The transmission component may be configured to transmit digital information and/or initiate communication with client computing platforms and/or servers. The digital information may include content particles of digital media files, image data and/or cookies, and/or other tracking information. The transmission component may operate in response to requests from, e.g., client computing platforms and/or a demand-side platform. In some embodiments, a particular client computing platform may request image data from the server, which may subsequently be transmitted, by the transmission component, to the particular requesting client computing platform. The digital information and/or tracking information transmitted by the transmission component may be used to track (browsing) activity on client computing platforms. In some embodiments, the transmission component may be configured to communicate a set of user identifiers and/or a set of characteristics of real estate transactions, for example in response to a request from a demand-side platform. Transmissions by the transmission component may be made in exchange for revenue from a requesting party, such as a demand-side platform.

Receipt of transmissions from client computing platforms may be responsive to browser software applications engaging markers and/or content particle identifiers, while being executed on client computing platforms, during presentations of digital media files in which the markers are embedded. Received transmissions may include content particle identifiers, digital media identifiers, information related to browsing activity on the client computing platforms from which the transmission are received, and/or other information. The digital media identifiers may have been included in the digital media files, the markers, or otherwise combined with received transmissions. Individual received transmissions may include individual digital media identifiers that identify one or more particular digital media files.

The report component may be configured to determine a set of content providers and/or web-based transaction-support systems that provided information relevant to one of more stages of real estate transactions. The report component may be configured to determine a set of content providers and/or web-based transaction-support systems that provided information relevant to one of more stages of particular real estate transactions that are related to a request from a demand-side platform and/or a response thereto.

The report component may be configured to aggregate occurrences of digital media files being presented through (real estate) search servers, for example per individual (real estate) search server. Results by the report component may be combined in reports, bills, messages, information presented for display, and/or other ways to combine and/or present results.

The report component may be configured to determine, based on information from other components, a fair compensation for the providers of digital content and/or web-based transaction-support systems. For example, the report component may be configured to determine compensation for the providers of digital content pertaining to real estate transactions, e.g. through a pay-per-listing model. The report component may be configured to determine compensations per domain, per domain identifier, per real estate search server, per legal entity or business associated with any of these, per content provider, per web-based transaction-support system, and/or any combination or aggregation thereof.

The report component may be configured to determine compensation for content providers and/or providers of digital content that meets specified criteria. For example, the determined compensation may be for a set of content providers of information pertaining to real estate transactions that has been presented to a particular set of users. The particular set of users may correspond to the determined set of user identifiers as described elsewhere herein, in relation to the operation of the criteria component.

The report component may be configured to produce bills, invoices, payments, and/or other financial documents and/or messages to initiate the collection of payments and/or the disbursement of payments based on the determined compensations.

One aspect of the disclosure relates to methods for providing targeted advertising on the internet. Online activities of users may be tracked and analyzed, correlated, linked, associated, and/or otherwise combined to gather information of interest to commercial entities. Examples of tracking mechanisms that may be used for web-based transaction-support systems and/or content providers are disclosed in U.S. patent application Ser. No. 13/655,299, titled “SYSTEM AND METHOD FOR TRACKING CONTENT THROUGH THE INTERNET”, filed Oct. 18, 2012, and U.S. patent application Ser. Nos. 13/530,467 and 13/626,419, both titled “REAL ESTATE CONTENT TRACKING ON THE INTERNET”, filed Jun. 22, 2012 and Sep. 25, 2012, respectively, all of which are hereby incorporated by reference herein in their entirety.

These and other objects, features, and characteristics of the servers, systems and/or methods disclosed herein, as well as the methods of operation and functions of the related elements of structure and the combination of parts and economies of manufacture, will become more apparent upon consideration of the following description and the appended claims with reference to the accompanying figures, all of which form a part of this specification, wherein like reference numerals designate corresponding parts in the various figures. It is to be expressly understood, however, that the figures are for the purpose of illustration and description only and are not intended as a definition of any limits. As used in the specification and in the claims, the singular form of “a”, “an”, and “the” include plural referents unless the context clearly dictates otherwise. As used in the specification and in the claims, in a list of items that includes the separator “and/or”, combinations of those items, insofar as practically possible, are envisioned as embodiments.

### BRIEF DESCRIPTION OF THE DRAWINGS

FIG. 1 illustrates a system configured to provide targeted advertising in accordance with one or more implementations.

FIG. 2 illustrates a method for providing targeted advertising in accordance with one or more implementations.

FIG. 3 illustrates a method for providing targeted advertising in accordance with one or more implementations.

### DETAILED DESCRIPTION

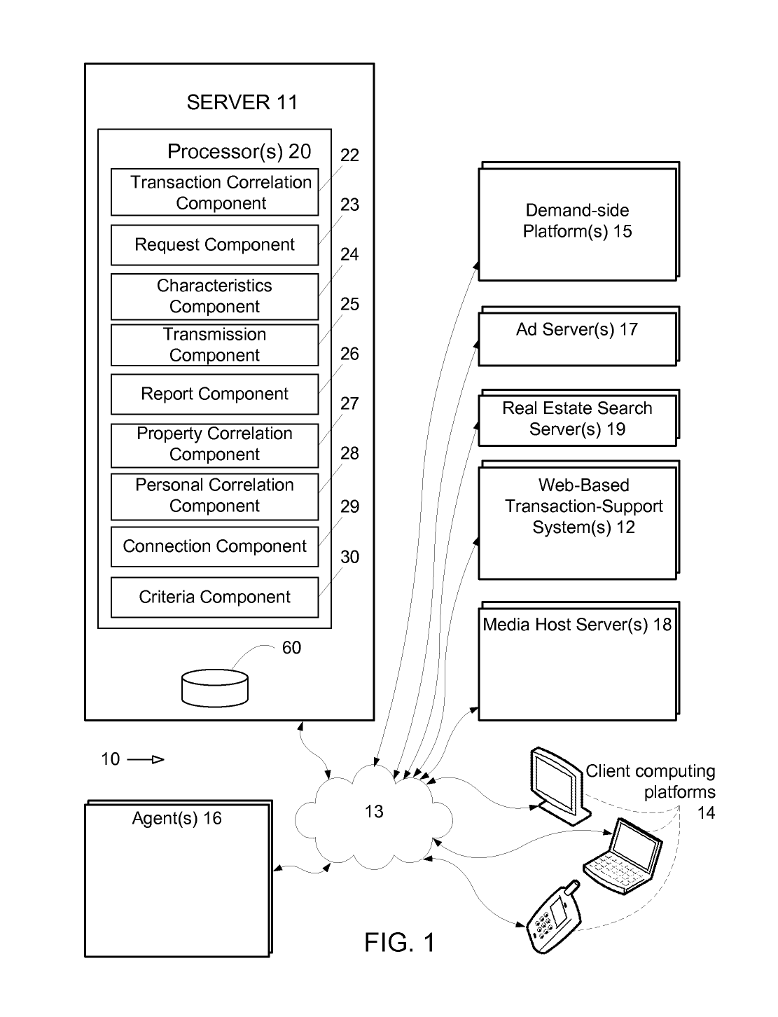

FIG. 1 illustrates a system 10 configured to provide targeted advertising on the internet. System 10 may facilitate communication between users and content providers, as well as between content providers. Providers of content may include, by way of non-limiting example, service providers, online services, media host servers, search servers, ad servers, demand-side platforms, web-based (property) transaction-support systems, companies involved in real estate transactions, listing agents, prospective real estate sellers, real estate agents, real estate brokers, real estate sales people, real estate agencies, brokerage firms, and/or other providers of content.

Search servers may include real estate search servers. The users of the search servers may include, by way of non-limiting example, prospective real estate buyers, buyer agencies, buyer brokerages, and/or other user/consumers of digital content. For example, system 10 may facilitate communication between people and entities that may be related to or interested in real estate and/or real estate content, as well as intermediaries and/or associates of such people and entities. By virtue of the tracking mechanisms described and/or incorporated herein, content providers may share in the (advertising and/or sales) revenue as appropriate, and/or be otherwise compensated. Payment models may include, by way of non-limiting example, a pay-per-listing model, a pay-per-view model, and/or other models.

Digital content, for example digital media files containing image data, listing information, property information, transaction information, and/or other information, may be presented for display to users on client computing platforms associated with those users. Individual users may request and/or view one or more digital media files through a website or web-based system. The website, its web pages, the web-based system, and/or the digital media files associated therewith, may be accessed by users, for example through browser software applications being executed on client computing platforms.

The presented digital media files may be hosted by, copied from, and/or linked to a media host server that provides storage for, management of, organization of, and/or access to the digital media files, and/or content particles of such digital media files. By way of non-limiting example, media host server may be a server associated with a multiple listing service, e.g. a multiple listing service for a particular geographical area. The media host server may manage a database and/or set of digital media files, e.g. pertaining to real estate within the particular geographical area. Digital media files pertaining to a particular real estate listing or to particular real estate content may have been provided to media host server by a prospective real estate seller, an associated listing agent, and/or another appropriate party representing an interest in a transaction involving the particular item of real estate. By virtue of one or more tracking mechanisms, a server may establish, among other information, which digital media files have been presented, optionally in conjunction with which (types of) ads, through which intermediate providers/channels, and/or to which users.

Referring to FIG. 1, system 10 may include one or more client computing platforms 14, one or more (buyer's or seller's) agents 16, one or more demand-side platforms 15, one or more ad servers 17, one or more (real estate) search servers 19, one or more web-based transaction-support systems 12, one or more media host servers 18, electronic storage 60, a server 11, one or more processors 20, and/or other components. The components in FIG. 1 may be communicatively coupled through one or more networks 13, including but not limited to the Internet. Server 11 may interchangeably be referred to as server system 11 throughout this disclosure. One or more of the processors 20, electronic storage 60, and/or other components may be included in server 11.

One or more processors 20 (interchangeably referred to herein as processor 20) may be configured to execute computer program components. The computer program components may include a transaction correlation component 22, a request component 23, a characteristics component 24, a transmission component 25, a report component 26, a property correlation component 27, a personal correlation component 28, a connection component 29, a criteria component 30, and/or other components. Information related to (prospective) real estate transactions may be gathered and/or tracked using one or more tracking mechanisms.

Transaction correlation component 22 may be configured to determine correlations between transactions and identifiers. Transactions may be related to one or more stages of (prospective) real estate transactions, such as a real estate purchase. The identifiers may include one or more of a user identifier, a device identifier, and/or other identifiers. Device identifiers may be related to one or more stages of (prospective) real estate transactions, in particular (prospective) real estate transactions that are correlated to (user and/or device) identifiers. Correlations between transactions and identifiers may be 1-to-1, 1-to-many, and/or many-to-many. For example, a particular user may use multiple client computing platforms 14 that are correlated to the same prospective transaction. For example, a particular user may be correlated to multiple prospective real estate transactions.

Request component 23 may be configured to obtain requests for information. In some embodiments, a request may be obtained from demand-side platform 15. The requested information may include one or more characteristics of (prospective) real estate transactions. In some embodiments, a request for one or more characteristics of a prospective real estate transaction may be based on information relevant to one or more stages of the prospective real estate transaction. The relevant information may be provided by one or more content providers, such as, by way of non-limiting example, web-based transaction-support system 12. The requested information may include one or more characteristics of a (prospective) real estate transaction that is correlated to a particular (user and/or device) identifier that is included in the request. Alternatively, and/or simultaneously, the requested information may include a request for a set of user identifiers that correspond to particular users (e.g. a subset of users for which information has been gathered). The particular users may be selected to meet one or more requested criteria. In some embodiments, the requested user identifiers may correspond to users that have been presented with particular digital content. The particular digital content may include and/or be related to a real estate transaction (or a real estate listing). The requested criteria may pertain to a real estate transaction. For example, the requested criteria may include a threshold or range for the property value of the real estate property that is the subject of a real estate transaction. For example, the request criteria may include a geographic area for real estate transactions. Multiple criteria may be logically combined (e.g. using logic operators such as “and,” “or,” “xor,” “not,” and/or other logical operators) for a request.

Characteristics component 24 may be configured to determine characteristics of (prospective) real estate transactions. Determinations by characteristics component 24 may be based on information relevant to one or more stages of (prospective) real estate purchases. Relevant information may be provided by content providers, web-based transaction-support systems 12, real estate agents, and/or other sources of information. In some embodiments, determinations by characteristics component 24 may be made such that one or more characteristics are determined of one or more particular (prospective) transactions.

Transmission component 25 may be configured to transmit digital information and/or initiate communication with client computing platforms 14, demand-side platforms 15, server 11, and/or other components of system 10. The digital information may include content particles of digital media files, image data and/or cookies, and/or other tracking information. For example, client computing platforms 14 interacting with web-based transaction-support systems 12 may engage one or more tracking mechanisms that gather and/or share transaction information (e.g. with transaction component 25).

Transmission component 25 may operate in response to requests from, e.g., client computing platforms 14 and/or demand-side platform 15. In some embodiments, a particular client computing platform 14 may request image data from a server (e.g. server 11), which may subsequently be transmitted, by transmission component 25, to the particular requesting client computing platform 14. The digital information and/or tracking information transmitted by transmission component 25 may be used to track (browsing) activity on client computing platforms 14. In some embodiments, transmission component 25 may be configured to communicate a set of user identifiers and/or a set of characteristics of real estate transactions, for example in response to a request from demand-side platform 15. Transmissions by transmission component 25 may be made in exchange for revenue from a requesting party, such as demand-side platform 15.

Property correlation component 27 may be configured to determine correlations between transactions and property identifiers. Property identifiers identify real estate properties. Property identifiers may include lot numbers, (part of) a street address, an identifier of an MLS listing, and/or other identifiers. For example, public records may include information to determine a correlation between a transaction and a property (identifier). For example, MLS listings/repositories may include information to determine a correlation between a transaction and a property (identifier). A particular (identified) real estate property may be associated with a particular (prospective) real estate transaction, and/or vice versa.

Personal correlation component 28 may be configured to determine correlations between users (or user identifiers) and device identifiers. A particular user (and/or user identifier) may be related to a particular transaction, and/or vice versa. A particular device identifier may be related to a particular transaction, and/or vice versa. For example, electronically signing a document pertaining to a particular transaction by using a web-based document management system may be a tracked activity that results in transaction information that correlates a particular user to a particular device or device identifier.

Connection component 29 may be configured to determine connections between device identifiers and property identifiers. Determinations by connection component 29 may be based on one or more determinations by other components of system 10, including but not limited to transaction correlation component 22, property correlation component 27, personal correlation component 28, and/or other components. For example, if a first correlation correlates between “A” and “B,” a second correlation correlates between “B” and “C,” and a third correlation correlates between “C” and “D,” wherein “A,” “B,” “C,” and “D” are different types of information and/or identifiers, then the combination of the first, second, and third correlation correlates between “A” and “D.” For example, “A” may be a property identifier, “B” may be a first type of user identifier (e.g. a name), “C” may be a second type of user identifier (e.g. a social security number), and “D” may be a device identifier. By correlating, connecting, linking, associating, and/or otherwise combining different types of information and/or identifiers, property identifier “A” may be connected to device identifier “D.” In some embodiments, connection component 29 may be configured to determine a connection between at least three items of information from the following list: a particular transaction identifier, a particular device identifier, a particular property identifier, and a particular user identifier.

In some embodiments, connection component 27 may be configured to determine an index, score, and/or ranking that indicate how much information is gathered for a particular transaction, a particular device, a particular property, and/or a particular user. More complete records of correlated information may be more valuable for targeted advertising. Alternatively, and/or simultaneously, an index, score, and/or ranking may indicate how advanced a prospective transaction is, e.g. in terms of which stages have been completed. Information regarding a more advanced prospective transaction may be more valuable for targeted advertising than information regarding preliminary, tentative, or early-stage prospective transactions.

Criteria component 30 may be configured to determine a set of (user and/or device) identifiers. Determinations by criteria component 30 may be performed responsive to a request, for example from demand-side platform 15. The request may include one of more specified criteria, including but not limited to any criteria described herein, such as the criteria related to characteristics of prospective real estate transactions. In some embodiments, a request for user identifiers corresponds to individual users that have interacted with particular content. For example, the particular content may pertain to real estate content that meets the one or more specified criteria. In some embodiments, a request for device identifiers corresponds to individual devices that have interacted with content providers for particular transactions (e.g. transactions that meet the one or more specified criteria). It is noted that the users, the devices, the transactions, or any combination thereof may be subject to one or more specified criteria (e.g. in a request).

The requested criteria may include a temporal component. For example, a request may specify that occurrences of interactions need to be at least a predetermined amount of time apart. For example, multiple occurrences may need to span multiple days. The temporal component may operate as a limit or maximum of occurrences for a predetermined time frame, such as a day. In other words, by virtue of using the temporal component in determining a set of user identifiers, criteria component 30 may be configured to distinguish, for example, between a first user who has viewed three items of real estate per day that match the specified criteria, for five consecutive days, and a second user who has viewed fifteen items of real estate that match the specified criteria in a single day.

In some embodiments, criteria component 30 is configured to access stored information that includes records of interactions for individual user identifiers and/or groups of user identifiers. Individual records may include attributes of transactions. Determinations by criteria component 30 may be based on filtering one or more attributes of individual records by one or more specified criteria that are included in a request.

Report component 26 may be configured to determine a set of content providers and/or web-based transaction-support systems 12 that provided information relevant to one of more stages of real estate transactions. Report component 26 may be configured to determine a set of content providers and/or web-based transaction-support systems 12 that provided information relevant to one of more stages of particular real estate transactions that are related to a request from demand-side platform 15 and/or a response thereto.

Report component 26 may be configured to aggregate occurrences of interactions and/or digital media files being presented. Results by report component 26 may be combined in reports, bills, messages, information presented for display, and/or other ways to combine and/or present results.

Report component 26 may be configured to determine, based on information from other components, a fair compensation for the providers of digital content, agents 16, and/or (owners/operators of) web-based transaction-support systems 12. For example, report component 26 may be configured to determine compensation for the providers of digital content pertaining to real estate transactions, e.g. through a pay-per-listing model. Compensations may be determined per domain, per domain identifier, per real estate search server, per legal entity or business associated with any of these, per content provider, per agent 16, per web-based transaction-support system 12, and/or any combination or aggregation thereof.

Report component 26 may be configured to determine compensation for content providers and/or providers of digital content that meets specified criteria. For example, the determined compensation may be for a set of content providers of information pertaining to real estate transactions that has been presented to a particular set of users. The particular set of users may correspond to the determined set of user identifiers as described elsewhere herein, in relation to the operation of criteria component 30. The compensation may be based on revenue for initiating communication of a determined set of (user and/or device) identifiers in response to a request, as described elsewhere herein. The compensation may be based on the presented digital content that pertains to real estate content that meets one or more specified criteria.

In some embodiments, a particular user identifier may be included in a determined set of user identifiers by virtue of a subset of the digital content that has been presented to the particular user. The subset of the digital content may have been provided by a plurality of content providers. The determined compensation could take into account exactly how many real estate content per content provider has contributed to the inclusion of the particular user. Alternatively, and/or simultaneously, the determined compensation may involve some or all of the content providers that have contributed digital content in the subset of digital content. Combinations and variations of multiple compensation schemes are contemplated within the scope of this disclosure. It is noted that there may be conceptual friction between a mathematically fair compensation scheme and a pragmatic compensation scheme for a system that limits the amount and/or level of detail for how closely the interactions with web-based transaction-support systems 12 and/or presentations of digital content can or will be tracked. Consider an example in which a particular user viewed real estate content of 50 items of real estate from a dozen content providers, but only 5 real estate properties match the specified criteria in the request. Increasingly complicated compensation schemes may be devised in such a situation.

Report component 26 may be configured to produce bills, invoices, payments, and/or other financial documents and/or messages to initiate the collection of payments and/or the disbursement of payments based on the determined (proposed) compensations. Report component 26 may be configured to produce, generate, and/or transmit financial documents to initiate the distribution of payments based on the determined intended compensations for, e.g., content providers.

One or more processors 20 may be configured to provide information processing capabilities in system 10 and/or server 11. As such, processor 20 may include one or more of a digital processor, an analog processor, a digital circuit designed to process information, an analog circuit designed to process information, a state machine, and/or other mechanisms for electronically processing information. Although processor 20 may be shown in FIG. 1 as a single entity, this is for illustrative purposes only. In some embodiments, processor 20 may include a plurality of processing units. These processing units may be physically located within the same device, or processor 20 may represent processing functionality of a plurality of devices operating in coordination (e.g., “in the cloud”, and/or other virtualized processing solutions).

It should be appreciated that although components 22-30, are illustrated in FIG. 1 as being co-located within a single processing unit, in implementations in which processor 20 includes multiple processing units, one or more of components 22-30 may be located remotely from the other components. The description of the functionality provided by the different components 22-30 described herein is for illustrative purposes, and is not intended to be limiting, as any of components 22-30 may provide more or less functionality than is described. For example, one or more of components 22-30 may be eliminated, and some or all of its functionality may be provided by other ones of components 22-30. As another example, processor 20 may be configured to execute one or more additional components that may perform some or all of the functionality attributed herein to one of components 22-30.

Electronic storage 60 of system 10 in FIG. 1 may comprise electronic storage media that stores information. The electronic storage media of electronic storage 60 may include one or both of system storage that is provided integrally (i.e., substantially non-removable) with server 11 and/or removable storage that is removably connectable to server 11 via, for example, a port (e.g., a USB port, a FireWire™ port, etc.) or a drive (e.g., a disk drive, etc.). Electronic storage 60 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), network-attached storage (NAS), and/or other electronically readable storage media. Electronic storage 60 may include virtual storage resources, such as storage resources provided via a cloud and/or a virtual private network. Electronic storage 60 may store software algorithms, information determined by processor 20, information received via client computing platforms 14, and/or other information that enable server 11 and system 10 to function properly. Electronic storage 60 may be separate components within system 10, or electronic storage 60 may be provided integrally with one or more other components of system 10 (e.g., processor 20).

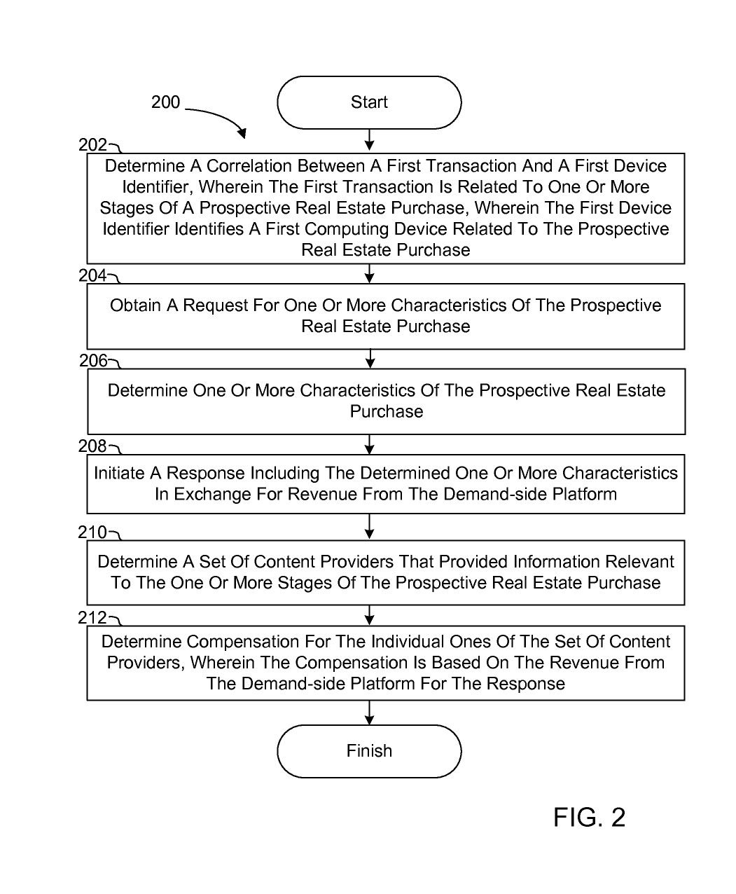

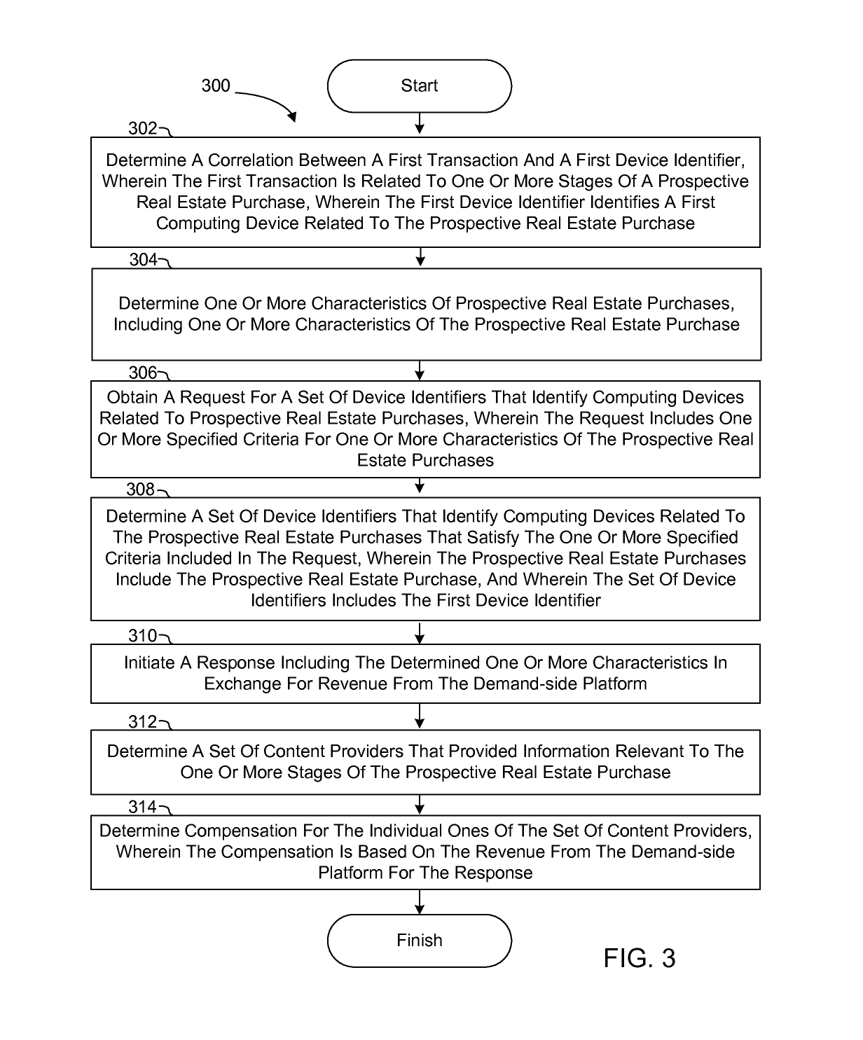

FIG. 2 and FIG. 3 illustrate a method 200 and a method 300 for providing targeted advertising on the internet. Regarding method 200, at an operation 202, a request is obtained for a set of user identifiers. The set of user identifiers corresponds to users that have been presented with digital content pertaining to real estate content. The request includes one or more specified criteria for the real estate content. In some embodiments, operation 202 may be performed by a request component that is the same as or similar to request component 29 (shown in FIG. 1 and described herein).

At an operation 202, a correlation is determined, on one or more physical processors, between a first transaction and a first device identifier. The first transaction is related to one or more stages of a prospective real estate purchase. The first device identifier identifies a first computing device related to the prospective real estate purchase. In some embodiments, operation 202 is performed by a transaction correlation component the same as or similar to transaction correlation component 22 (shown in FIG. 1 and described herein).

At an operation 204, a request is obtained, from a demand-side platform, for one or more characteristics of the prospective real estate purchase. The one or more characteristics may be based on information relevant to the one or more stages of the prospective real estate purchase. The relevant information is provided by one or more content providers. In some embodiments, operation 204 is performed by a request component the same as or similar to request component 23 (shown in FIG. 1 and described herein).

At an operation 206, one or more characteristics of the prospective real estate purchase are determined. In some embodiments, operation 206 is performed by a characteristics component the same as or similar to characteristics component 24 (shown in FIG. 1 and described herein).

At an operation 208, a response is initiated that included the determined one or more characteristics in exchange for revenue from the demand-side platform. In some embodiments, operation 208 is performed by a transmission component the same as or similar to transmission component 25 (shown in FIG. 1 and described herein).

At an operation 210, a set of content providers is determined that provided information relevant to the one or more stages of the prospective real estate purchase. In some embodiments, operation 210 is performed by a report component the same as or similar to report component 26 (shown in FIG. 1 and described herein).

At an operation 212, compensation is determined for the individual ones of the set of content providers. The compensation is based on the revenue from the demand-side platform for the response. In some embodiments, operation 212 is performed by a report component the same as or similar to report component 26 (shown in FIG. 1 and described herein).

Regarding method 300, at an operation 302, a correlation is determined, on the one or more physical processors, between a first transaction and a first device identifier. The first transaction is related to one or more stages of a prospective real estate purchase. The first device identifier identifies a first computing device related to the prospective real estate purchase. In some embodiments, operation 302 is performed by a transaction correlation component the same as or similar to transaction correlation component 22 (shown in FIG. 1 and described herein).

At an operation 304, one or more characteristics are determined of prospective real estate purchases such that the characteristics component is configured to determine one or more characteristics of the prospective real estate purchase. In some embodiments, operation 304 is performed by a characteristics component the same as or similar to characteristics component 24 (shown in FIG. 1 and described herein).

At an operation 306, a request is obtained, from a demand-side platform, for a set of device identifiers that identify computing devices related to prospective real estate purchases. The request includes one or more specified criteria for one or more characteristics of the prospective real estate purchases. The one or more characteristics may be based on information relevant to the one or more stages of the prospective real estate purchase. The relevant information is provided by one or more content providers. In some embodiments, operation 306 is performed by a request component the same as or similar to request component 23 (shown in FIG. 1 and described herein).

At an operation 308, a set of device identifiers is determined that identify computing devices related to the prospective real estate purchases that satisfy the one or more specified criteria included in the request. The prospective real estate purchases include the prospective real estate purchase. The set of device identifiers includes the first device identifier. In some embodiments, operation 308 is performed by a criteria component the same as or similar to criteria component 30 (shown in FIG. 1 and described herein).

At an operation 310, a response is initiated that includes the determined set of device identifiers in exchange for revenue from the demand-side platform. In some embodiments, operation 310 is performed by a transmission component the same as or similar to transmission component 25 (shown in FIG. 1 and described herein).

At an operation 312, a set of content providers is determined that provided information relevant to the one or more stages of the prospective real estate purchase. In some embodiments, operation 312 is performed by a report component the same as or similar to report component 26 (shown in FIG. 1 and described herein).

At an operation 314, compensation is determined for the individual ones of the set of content providers. The compensation is based on the revenue from the demand-side platform for the response. In some embodiments, operation 314 is performed by a report component the same as or similar to report component 26 (shown in FIG. 1 and described herein).

The operations of method 200 and method 300 presented herein are intended to be illustrative. In some embodiments, method 200 and/or method 300 may be accomplished with one or more additional operations not described, and/or without one or more of the operations discussed. Additionally, the order in which the operations of method 200 and method 300 are illustrated in FIG. 2 and FIG. 3 and described herein is not intended to be limiting.

In some embodiments, method 200 and/or method 300 may be implemented in one or more processing devices (e.g., a server, a digital processor, an analog processor, a digital circuit designed to process information, an analog circuit designed to process information, and/or other mechanisms for electronically processing information). The one or more processing devices may include one or more devices executing some or all of the operations of method 200 and/or method 300 in response to instructions stored electronically on an electronic storage medium. The one or more processing devices may include one or more devices configured through hardware, firmware, and/or software to be specifically designed for execution of one or more of the operations of method 200 and/or method 300.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to provide targeted advertising, the system comprising:
one or more processors configured to execute computer program components, the computer program components comprising:
a transaction correlation component configured to determine a correlation between a first transaction and a first device identifier, wherein the first transaction is related to one or more stages of a prospective real estate purchase, wherein the first device identifier identifies a first computing device related to the prospective real estate purchase;
a request component configured to obtain, from a demand-side platform, a request for one or more characteristics of the prospective real estate purchase, wherein the request includes the first device identifier;
a characteristics component configured to determine one or more characteristics of the prospective real estate purchase;
a transmission component configured to initiate, responsive to obtaining the request, a response including the determined one or more characteristics in exchange for revenue from the demand-side platform; and
a report component configured to determine a set of content providers that provided information relevant to the one or more stages of the prospective real estate purchase, wherein the report component is further configured to determine compensation for the individual ones of the set of content providers, wherein the compensation is based on the revenue from the demand-side platform for the response.

2. The system of claim 1, further comprising:
a property correlation component configured to determine a secondary correlation between the first transaction and a first property identifier, wherein the first property identifier identifies a first real estate property, wherein the prospective real estate purchase is associated with the first real estate property.

3. The system of claim 2, further comprising:
a personal correlation component configured to determine a tertiary correlation between a first user identifier that identifies a first user and the first device identifier, wherein the first transaction is related to the first user.

4. The system of claim 3, further comprising:
a connection component configured to determine a first connection between the first device identifier and a first property identifier, wherein the first property identifier identifies a first real estate property, wherein the prospective real estate purchase is associated with the first real estate property, and wherein the determination by the connection component is based on one or more determinations by at least one of the transaction correlation component, the property correlation component, and the personal correlation component.

5. The system of claim 1, wherein the stages of the prospective real estate purchase include one or more of a property searching stage, a mortgage searching stage, an agent searching stage, a loan application stage, a loan approval stage, an agent contracted stage, an offer submission stage, an offer acceptance stage, an escrow stage, a purchase completion stage, and a post-purchase stage.

6. The system of claim 1, wherein the transaction correlation component is configured to obtain information about the prospective real estate purchase from one or more web-based transaction-support systems, wherein the web-based transaction-support systems include web-based public records, real estate search sites, multiple listing service (MLS) sites, real estate agents sites, real estate brokers sites, agent-buyer collaboration sites, web-based loan approval systems, web-based real estate transaction management systems, web-based point-of-sale systems, web-based customer relationship management (CRM) systems, comparative market analysis (CMA) systems, web-based document management systems, web-based form management systems, and web-based escrow systems.

7. The system of claim 6, wherein the transmission component is further configured to receive transmissions, from client computing platforms of users, reflecting browsing activity that indicates, by virtue of the client computing platforms engaging digital markers embedded in web pages, which users have accessed which ones of the one or more web-based transaction-support systems,
wherein an individual received transmission includes:
i) an individual device identifier that corresponds to an individual computing device associated with an individual user, and
ii) a transaction identifier that identifies a prospective real estate transaction,
and wherein the determination, by the transaction component, of the correlation between the first transaction and the first device identifier is made based on the information received by the transmission component.

8. The system of claim 1, wherein the transaction correlation component is configured to obtain information about the prospective real estate purchase from real estate agents representing prospective buyers of real estate.

9. The system of claim 4, wherein the connection component is configured to determine a second connection between at least three of the first transaction, the first device identifier, the first property identifier, and the first user identifier.

10. The system of claim 1, wherein the first device identifier includes one or more of an internet protocol (IP) address, a media access control (MAC) address, a browser cookie, and information about hardware and/or software configuration of a client computing platform.

11. A system configured to provide targeted advertising, the system comprising:
one or more processors configured to execute computer program components, the computer program components comprising:
a transaction correlation component configured to determine a correlation between a first transaction and a first device identifier, wherein the first transaction is related to one or more stages of a prospective real estate purchase, wherein the first device identifier identifies a first computing device related to the prospective real estate purchase;
a characteristics component configured to determine one or more characteristics of prospective real estate purchases such that the characteristics component is configured to determine one or more characteristics of the prospective real estate purchase;
a request component configured to obtain, from a demand-side platform, a request for a set of device identifiers that identify computing devices related to prospective real estate purchases, wherein the request includes one or more specified criteria for one or more characteristics of the prospective real estate purchases;
a criteria component configured to determine a set of device identifiers that identify computing devices related to the prospective real estate purchases that satisfy the one or more specified criteria included in the request, wherein the prospective real estate purchases include the prospective real estate purchase, and wherein the set of device identifiers includes the first device identifier;
a transmission component configured to initiate, responsive to obtaining the request, a response including the determined set of device identifiers in exchange for revenue from the demand-side platform; and
a report component configured to determine a set of content providers that provided information relevant to the one or more stages of the prospective real estate purchase, wherein the report component is further configured to determine compensation for the individual ones of the set of content providers, wherein the compensation is based on the revenue from the demand-side platform for the response.

12. The system of claim 11, further comprising a property correlation component configured to determine a secondary correlation between the first transaction and a first property identifier, wherein the first property identifier identifies a first real estate property, wherein the prospective real estate purchase is associated with the first real estate property.

13. The system of claim 12, further comprising:
a personal correlation component configured to determine a tertiary correlation between a first user identifier that identifies a first user and the first device identifier, wherein the first transaction is related to the first user.

14. The system of claim 13, further comprising:
a connection component configured to determine a first connection between the first device identifier and a first property identifier, wherein the first property identifier identifies a first real estate property, wherein the prospective real estate purchase is associated with the first real estate property, and wherein the determination by the connection component is based on one or more determinations by at least one of the transaction correlation component, the property correlation component, and the personal correlation component.

15. The system of claim 11, wherein the stages of the prospective real estate purchase include one or more of a property searching stage, a mortgage searching stage, an agent searching stage, a loan application stage, a loan approval stage, an agent contracted stage, an offer submission stage, an offer acceptance stage, an escrow stage, and a purchase completion stage.

16. The system of claim 11, wherein the transaction correlation component is configured to obtain information about the prospective real estate purchase from one or more web-based transaction-support systems, wherein the web-based transaction-support systems include web-based public records, real estate search sites, multiple listing service (MLS) sites, real estate agents sites, real estate brokers sites, agent-buyer collaboration sites, web-based loan approval systems, web-based real estate transaction management systems, web-based point-of-sale systems, web-based customer relationship management (CRM) systems, comparative market analysis (CMA) systems, web-based document management systems, web-based form management systems, and web-based escrow systems.

17. The system of claim 16, wherein the transmission component is further configured to receive transmissions, from client computing platforms of users, reflecting browsing activity that indicates, by virtue of the client computing platforms engaging digital markers embedded in web pages, which users have accessed which ones of the one or more web-based transaction-support systems,
wherein an individual received transmission includes:
i) an individual device identifier that corresponds to an individual computing device associated with an individual user, and
ii) a transaction identifier that identifies a prospective real estate transaction,
and wherein the determination, by the transaction component, of the correlation between the first transaction and the first device identifier is made based on the information received by the transmission component.

18. The system of claim 11, wherein the transaction correlation component is configured to obtain information about the prospective real estate purchase from real estate agents representing prospective buyers of real estate.

19. The system of claim 14, wherein the connection component is configured to determine a second connection between at least three of the first transaction, the first device identifier, the first property identifier, and the first user identifier.

20. The system of claim 11, wherein the first device identifier includes one or more of an internet protocol (IP) address, a media access control (MAC) address, a browser cookie, and information about hardware and/or software configuration of a client computing platform.

21. A computer-implemented method to provide targeted advertising, the method being implemented in a computer system that includes one or more physical processors, the method comprising:
determining, on the one or more physical processors, a correlation between a first transaction and a first device identifier, wherein the first transaction is related to one or more stages of a prospective real estate purchase, wherein the first device identifier identifies a first computing device related to the prospective real estate purchase;
obtaining, from a demand-side platform, a request for one or more characteristics of the prospective real estate purchase;
initiating a response including the determined one or more characteristics in exchange for revenue from the demand-side platform;
determining a set of content providers that provided information relevant to the one or more stages of the prospective real estate purchase; and
determining compensation for the individual ones of the set of content providers, wherein the compensation is based on the revenue from the demand-side platform for the response.

22. The method of claim 21, wherein the stages of the prospective real estate purchase include one or more of a property searching stage, a mortgage searching stage, an agent searching stage, a loan application stage, a loan approval stage, an agent contracted stage, an offer submission stage, an offer acceptance stage, an escrow stage, and a purchase completion stage.

23. The method of claim 21, wherein determining the correlation is based on information about the prospective real estate purchase from one or more web-based transaction-support systems, wherein the web-based transaction-support systems include web-based public records, real estate search sites, multiple listing service (MLS) sites, real estate agents sites, real estate brokers sites, agent-buyer collaboration sites, web-based loan approval systems, web-based real estate transaction management systems, web-based point-of-sale systems, web-based customer relationship management (CRM) systems, comparative market analysis (CMA) systems, web-based document management systems, web-based form management systems, and web-based escrow systems.

24. A computer-implemented method to provide targeted advertising, the method being implemented in a computer system that includes one or more physical processors, the method comprising:
determining, on the one or more physical processors, a correlation between a first transaction and a first device identifier, wherein the first transaction is related to one or more stages of a prospective real estate purchase, wherein the first device identifier identifies a first computing device related to the prospective real estate purchase;
determining one or more characteristics of prospective real estate purchases such that the characteristics component is configured to determine one or more characteristics of the prospective real estate purchase;
obtaining, from a demand-side platform, a request for a set of device identifiers that identify computing devices related to prospective real estate purchases, wherein the request includes one or more specified criteria for one or more characteristics of the prospective real estate purchases;
determining a set of device identifiers that identify computing devices related to the prospective real estate purchases that satisfy the one or more specified criteria included in the request, wherein the prospective real estate purchases include the prospective real estate purchase, and wherein the set of device identifiers includes the first device identifier;
initiating a response including the determined set of device identifiers in exchange for revenue from the demand-side platform;
determining a set of content providers that provided information relevant to the one or more stages of the prospective real estate purchase; and
determining compensation for the individual ones of the set of content providers, wherein the compensation is based on the revenue from the demand-side platform for the response.

25. The method of claim 24, wherein the stages of the prospective real estate purchase include one or more of a property searching stage, a mortgage searching stage, an agent searching stage, a loan application stage, a loan approval stage, an agent contracted stage, an offer submission stage, an offer acceptance stage, an escrow stage, and a purchase completion stage.

26. The method of claim 24, wherein determining the correlation is based on information about the prospective real estate purchase from one or more web-based transaction-support systems, wherein the web-based transaction-support systems include web-based public records, real estate search sites, multiple listing service (MLS) sites, real estate agents sites, real estate brokers sites, agent-buyer collaboration sites, web-based loan approval systems, web-based real estate transaction management systems, web-based point-of-sale systems, web-based customer relationship management (CRM) systems, comparative market analysis (CMA) systems, web-based document management systems, web-based form management systems, and web-based escrow systems.
